(19) United States
(12) Patent Application Publication
(10) Pub. No.: US 2011/0125803 A1
(43) Pub. Date: May 26, 2011

(54) USABILITY EVALUATION APPARATUS, USABILITY EVALUATION METHOD, AND PROGRAM

(75) Inventor: Toshiyuki Asahi, Tokyo (JP)

(73) Assignee: NEC CORPORATION, TOKYO (JP)

(21) Appl. No.: 13/055,716

(22) PCT Filed: Jul. 16, 2009
(86) PCT No.: PCT/JP2009/062854

§ 371 Date: Jan. 25, 2011

(30) Foreign Application Priority Data
Aug. 5, 2008 (JP) 2008-201848

(51) Int. Cl. G06F 17/30

(52) U.S. Cl. 707/797; 707/E17.012

(57) ABSTRACT

A usability evaluation apparatus evaluates usability of evaluation objects by evaluation items (201 and 202) that have a hierarchical structure that is divided into a plurality of hierarchies and supplies usability evaluation points (206) that are the evaluation results to an output element. The output element is caused to supply as output a tree map in which are represented rectangular regions that have shapes that accord with degrees of importance (203 and 204) that indicate the relative importance of evaluation items (201 and 202) in the hierarchy and that indicate the evaluation items (201 and 202) such that the hierarchical structure can be distinguished and graphs that indicate the absolute values of usability evaluation points (206) such that the graphs are depicted in rectangular regions (501) that indicate the lowest-level evaluation items on the tree map according to the shape of the rectangular regions (501).

### TECHNICAL FIELD

The present invention relates to a usability evaluation apparatus, a usability evaluation method, and a program that supply usability evaluation results.

### BACKGROUND ART

Usability that indicates the ease of use of a service, information processing system, or terminal is receiving attention in recent years. With this attention, methods of comprehensively comparing and evaluating various information systems, terminals, or services are being developed.

To comprehensively compare and evaluate usability, it is essential that data that have been quantized as evaluation results be supplied as output such that the user can comprehend the evaluation results without misunderstanding.

Non-Patent Document 1 discloses an example of a method of supplying data that have been quantized as an evaluation result.

In the method disclosed in Non-Patent Document 1, evaluation items are hierarchized with one or more evaluation items set in each hierarchy. The evaluator of usability then determines usability evaluation points for each object of evaluation with respect to the lowest-level evaluation items.

In this method, a scheme is implemented to compute appropriate evaluation results by first determining degrees of importance between evaluation items of the same hierarchy, and then adding to usability evaluation points that are determined by the evaluator, degrees of importance that are conferred to evaluation items that have been evaluated and degrees of importance that are conferred to evaluation items of a higher-order hierarchy that correspond to these evaluation items.

FIG. 1 shows an example of evaluation items of a higher-order hierarchy in a case in which the usability evaluation of personal computers is carried out by a method in which evaluation items are hierarchized and degrees of importance are determined between evaluation items of the same hierarchy.

As shown in FIG. 1, in this example, there are 13 evaluation items in the higher-order hierarchy, and a plurality of lower-order evaluation items are set for each of these higher-order hierarchy evaluation items.

The following explanation regards a method in which the method disclosed in the above-mentioned Non-Patent Document is used to carry out usability evaluation of seven models of personal computers and supply the results when evaluation items such as shown in FIG. 1 have been set as the higher-order hierarchy.

The scores of seven models of personal computers are determined by the evaluator for evaluation items of a lower-order hierarchy that correspond to each of the evaluation item of the higher-order hierarchy shown in FIG. 1. Although the evaluation items of the lower-order hierarchy are not here clearly described, “ease of typing” or “ease of comprehending key layout” can be considered as lower-order hierarchy evaluation items of the higher-order hierarchy evaluation item “keyboard.”

Scores are next computed by multiplying the scores of lower-order hierarchy evaluation items that have been determined by degrees of importance that have been conferred to the lower-order hierarchy evaluation items.

Scores of the higher-order hierarchy evaluation items are next computed by adding up the scores of lower-order hierarchy evaluation items that have been multiplied by the degrees of importance in units of the higher-order hierarchy evaluation items (for example, “keyboard”). For example, the score for a higher-order hierarchy evaluation item is computed by adding the score for “ease of typing” and the score for “ease of comprehension of keyboard layout.”

Scores are next computed by multiplying the scores of the higher-order hierarchy evaluation items that have been computed by the degrees of importance that were conferred to these higher-order hierarchy evaluation items.

Usability evaluation points of each object of evaluation are then computed by adding the scores of the higher-order hierarchy evaluation items that were multiplied by the degrees of importance in units of the objects of evaluation, and a graph of the usability evaluation points that have been computed is supplied as output.

FIG. 2 shows the usability evaluation result of seven models of personal computers that are the objects of evaluation when the evaluation items shown in FIG. 1 are taken as the higher-order hierarchy evaluation items. The names of the seven models of personal computers are here taken as personal computers A-G.

As shown in FIG. 2, in the usability evaluation results of the seven models of personal computers A-G, the usability evaluation points are visualized according to personal computers A-G that are the objects of evaluation and according to the higher-order hierarchy evaluation items by the shape (height) of bars divided into the higher-order hierarchy evaluation item units shown in FIG. 1 such that the user of the evaluation results can comprehend the evaluation results without any misunderstanding.

In addition, another method of supplying data that have been quantized as evaluation results is disclosed in Non-Patent Document 2. The method disclosed in Non-Patent Document 2 is referred to as tree mapping, and quantitative data having a hierarchical structure are supplied depicted as rectangular regions that accord with, for example, the hierarchical structure or the quantities indicated by the quantitative data.

FIG. 3 is a view for explaining the algorithm for depicting the rectangular regions in tree mapping, (a) showing the hierarchical structure of quantitative data and the ratio of the quantities indicated by each item of quantitative data in the same hierarchy, and (b) showing the algorithm of the depiction of rectangular regions that accord with the hierarchical structure of quantitative data and the ratio of the quantities indicated by each item of quantitative data in the same hierarchy. The depiction algorithm described in FIG. 3(b) is referred to as a Slice & Dice mode.

In FIG. 3(a), A, A-1-A-3, and A-2-1-A-2-4 indicate quantitative data, and the numbers enclosed in the parentheses following these codes indicate the ratios of the quantitative data in the same hierarchy.

In the Slice & Dice mode shown in FIG. 3(b), rectangular region 301 that shows the entirety of A of quantitative data is first depicted.

Next, rectangular region 301 is divided in the vertical or horizontal direction in accordance with the ratios of quantitative data A-1-A-3 of the first hierarchy shown in FIG. 3(a) to generate a plurality of small rectangular regions 302. At this time, the area ratio of each small rectangular region 302 is divided so as to equal the ratio of quantitative data A-1-A-3 of the first hierarchy. In this case, the regions are divided in the vertical direction.

Small rectangular regions 302 are next divided according to the proportions of quantitative data A-2-1-A-2-4 of the second hierarchy shown in FIG. 3(a) to generate a plurality of small rectangular regions 303. At this time, the region is divided in a direction that differs from the direction at the time of division of rectangular region 301. In addition, the division is implemented such that the area ratios of each of small regions 303 are equivalent to the ratios of quantitative data A-2-1-A-2-4 of the second hierarchy.

Although a case has been described here in which there are two hierarchies, even when the number of hierarchies is greater than two, recursive repetition of the division of the above-described small rectangular regions for all hierarchies enables the simultaneous expression of the hierarchical structure and ratios of the quantitative data in one rectangular region 301. In actual use, blank regions 304 referred to as offsets, as shown in the lowest stage of FIG. 3(b), are frequently added to facilitate the visual confirmation of the relations of hierarchies.

### Documents of the Prior Art

### Non-Patent Documents

Non-Patent Document 1: Ikuko Okamoto, et. al, “The Study of Methods of Evaluating Usability (First Report)—Investigation of a PC Usability Evaluation Model.” 1995, Proceedings of the 25^{th} Conference of the Kanto Branch of the Japan Ergonomics Society, pp. 38-39.

Non-Patent Document 2: Brian Johnson, et. al, “Tree Maps: a space-filling approach to the visualization of hierarchical information structures,” Proceedings of the 2^{nd} International IEEE Visualization Conference, pp. 284-291, October 1991.

### DISCLOSURE OF THE INVENTION

### Problem to be Solved by the Invention

Although the use of the technology described in Non-Patent Document 1 enables the expression of evaluation items and usability evaluation points of evaluation objects for evaluation items, as shown by the bar graph shown in FIG. 2, only the evaluation items of one hierarchy and the usability evaluation points for these evaluation items can be simultaneously expressed. In other words, the problem arises that usability evaluation points cannot be compared and evaluated while looking at the hierarchical evaluation items.

In addition, although the use of the technology of Non-Patent Document 2 enables the expression of hierarchical evaluation items and degrees of importance, the problem arises that the expression of absolute values of the usability evaluation points of each evaluation object cannot be expressed as in the tree map shown in FIG. 3. This is because the tree map shown in FIG. 3 is a method of dividing rectangular regions by the ratios of each item of quantitative data, and when the evaluation results of each evaluation object are given as a score, the size of the value cannot be directly expressed.

For example, even when the scores of evaluation objects A and B for evaluation items that are on a tree map are expressed by small rectangular regions having an area ratio of 1:2, it cannot be distinguished from the tree map itself if the score of evaluation object A is 1 point and the score of evaluation object B is 2 points or the score of evaluation object A is 3 points and the score of evaluation object B is 6 points.

It is an object of the present invention to provide a usability evaluation apparatus, a usability evaluation method, and a program that not only enable the simultaneous expression of hierarchical evaluation items and usability evaluation points, but that can further facilitate the direct comparison of usability evaluation points.

### Means for Solving the Problem

The present invention for achieving the above-described objects is a usability evaluation apparatus that evaluates usability of evaluation objects by means of evaluation items that have a hierarchical structure that is divided into a plurality of hierarchies and that supplies as output to an output means usability evaluation points that are the evaluation results; wherein the usability evaluation apparatus causes the output means to supply as output: a tree map that has a shape that accords with degrees of importance that indicate the relative importance of the evaluation items within the hierarchy and that represents regions of the evaluation items such that the hierarchical structure can be distinguished and graphs that indicate the absolute values of the usability evaluation points such that the graphs are depicted in the regions that indicate the lowest-level evaluation items on the tree map in accordance with the shapes of the regions.

In addition, the present invention is a usability evaluation method in a usability evaluation apparatus that evaluates usability of evaluation objects by means of evaluation items that have a hierarchical structure that is divided into a plurality of hierarchies and that supplies usability evaluation points that are evaluation results to an output means; wherein the usability evaluation method includes a process of causing the output means to supply as output a tree map that has a shape that accords with degrees of importance that indicate the relative importance of the evaluation items within the hierarchical structure and that represents regions that indicate the evaluation items such that the hierarchical structure can be distinguished and graphs that indicate absolute values of the usability evaluation points such that the graphs are depicted within the regions that indicate the lowest level evaluation items on the tree map in accordance with the shapes of the regions.

Finally, the program of the present invention causes a usability evaluation apparatus, which evaluates the usability of evaluation objects by means of evaluation items that have a hierarchical structure that is divided into a plurality of hierarchies and that supplies usability evaluation points that are the evaluation results to an output means, to execute a function of: causing the output means to supply as output a tree map that has a shape that accords with degrees of importance that indicate the relative importance of the evaluation items within the hierarchical structure and that represents regions that indicate the evaluation items such that the hierarchical structure can be distinguished and graphs that indicate the absolute values of the usability evaluation points such that the graphs are depicted within the regions that indicate the lowest-level evaluation items on the tree map in accordance with the shapes of the regions.

### EFFECT OF THE INVENTION

Due to the constitution as described hereinabove, the present invention enables the simultaneous expression of hierarchical evaluation items and usability evaluation points and can further facilitate the direct comparison of usability evaluation points.

### BRIEF DESCRIPTION OF THE DRAWINGS

FIG. 1 shows an example of the evaluation items of a higher-order hierarchy when usability evaluation is to be carried out for personal computers by means of a method in which evaluation items are hierarchized and degrees of importance are determined between evaluation items of the same hierarchy;

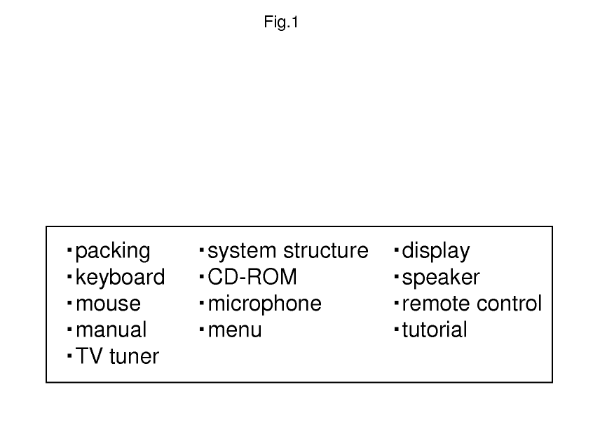

FIG. 2 shows the usability evaluation results of personal computers when the evaluation items shown in FIG. 1 are taken as the evaluation items of a higher-order hierarchy;

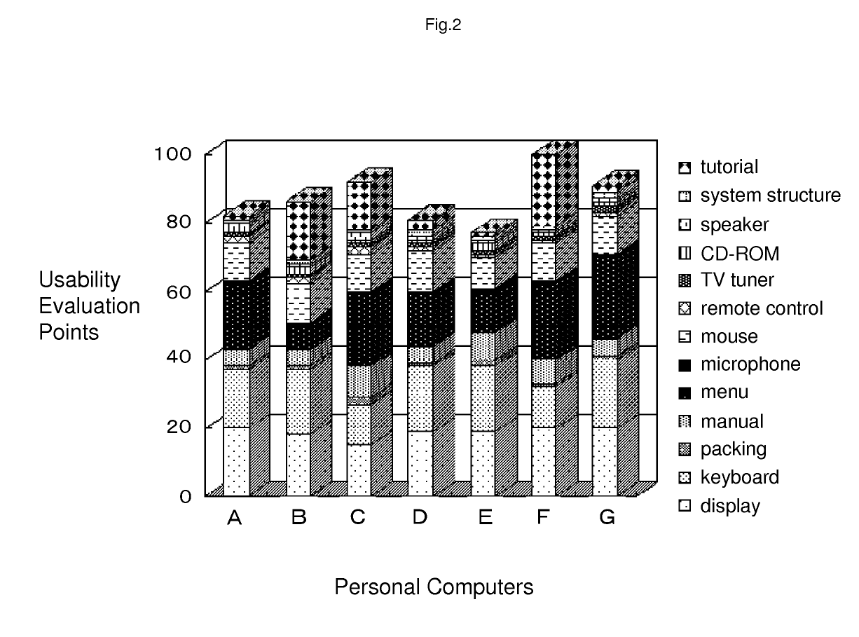

FIG. 3 is a view for describing an algorithm for depicting rectangular regions on a tree map;

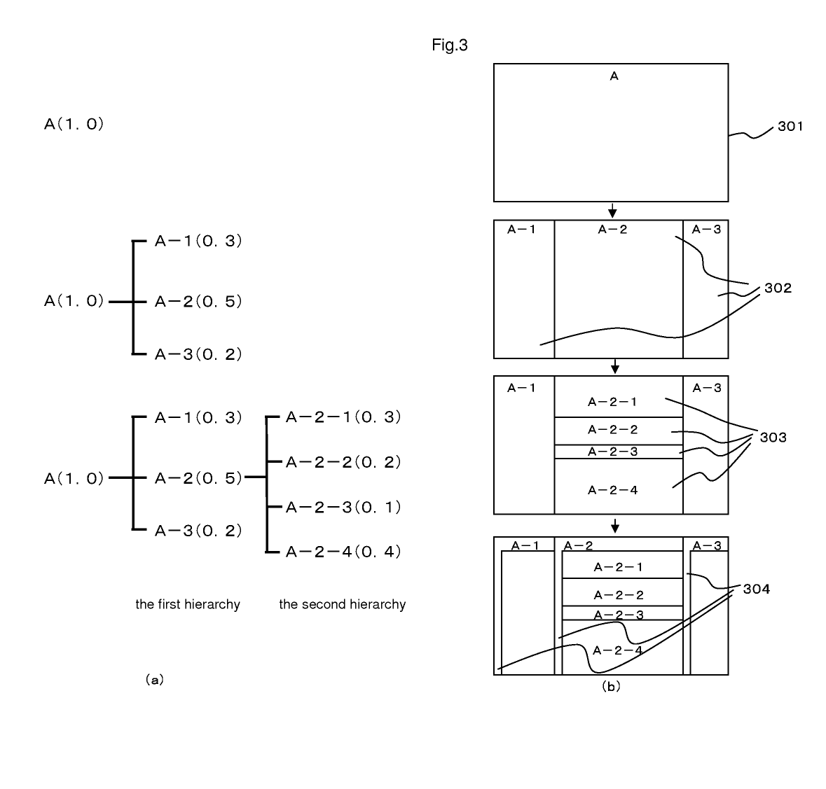

FIG. 4 is a block diagram showing the configuration of the first exemplary embodiment of the usability evaluation apparatus of the present invention;

FIG. 5 is a view for describing an example of evaluation items and the hierarchical structure of evaluation items that are stored by an evaluation item storage unit, degrees of importance that are stored by a degree of importance storage unit, and usability evaluation points that are stored by an evaluation point storage unit of the storage device shown in FIG. 4;

FIG. 6 is a flow chart for describing an example of the operations of supplying usability evaluation results by the usability evaluation apparatus shown in FIG. 4;

FIG. 7 shows an example of a tree map that is supplied by the output apparatus shown in FIG. 4;

FIG. 8 shows an example of the state in which graphs of usability evaluation points are depicted on the tree map shown in FIG. 7;

FIG. 9 shows another example of the state in which graphs of usability evaluation points are depicted on the tree map shown in FIG. 7;

FIG. 10 is a block diagram showing the configuration of the second exemplary embodiment of the usability evaluation apparatus of the present invention;

FIG. 11 is a flow chart for describing an example of the operations of supplying usability evaluation results by the usability evaluation apparatus shown in FIG. 10;

FIG. 12 shows another example of the state in which graphs of usability evaluation points are depicted on the tree map shown in FIG. 7;

FIG. 13 shows another example of the tree map that is supplied as output by the output apparatus shown in FIG. 10; and

FIG. 14 shows an example of the state in which graphs of usability evaluation points are depicted on the tree map shown in FIG. 13.

### BEST MODE FOR CARRYING OUT THE INVENTION

Exemplary embodiments of the present invention are next described with reference to the accompanying drawings.

### First Exemplary Embodiment

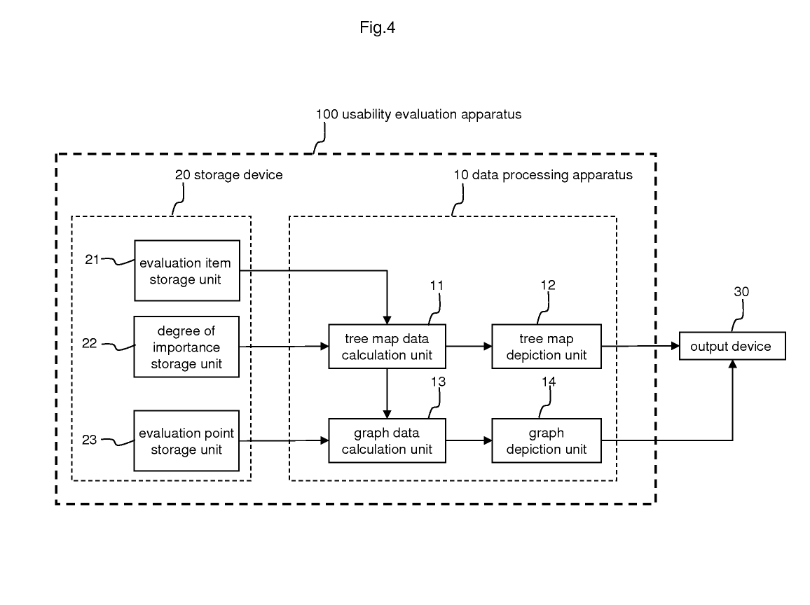

FIG. 4 is a block diagram showing the configuration of the first exemplary embodiment of the usability evaluation apparatus of the present invention.

As shown in FIG. 4, usability evaluation apparatus 100 of the present exemplary embodiment is provided with data processing apparatus 10 that operates under program control, and storage device 20. In addition, output device 30, which is an output means such as a display or printer that supplies usability evaluation results as output, is connected to data processing apparatus 10.

Storage device 20 is equipped with evaluation item storage unit 21, degree of importance storage unit 22, and evaluation point storage unit 23.

Evaluation item storage unit 21 stores evaluation items in usability evaluation and the hierarchical structure of the evaluation items.

Degree of importance storage unit 22 stores the degrees of importance of evaluation items in association with the evaluation items.

Evaluation point storage unit 23 stores the usability evaluation points of the lowest-order evaluation items that are determined by the evaluator of usability evaluation for evaluation objects of usability evaluation in association with the lowest-order evaluation items. The usability evaluation points are normally determined by one or a plurality of evaluators.

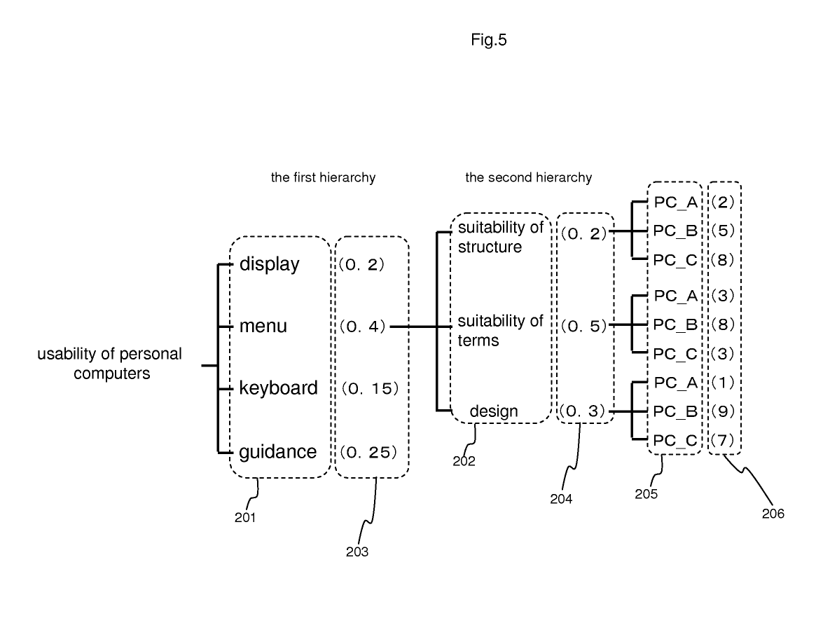

FIG. 5 is a view for describing an example of the evaluation items and the hierarchical structure of the evaluation items that are stored by evaluation item storage unit 21 of storage device 20 shown in FIG. 4, the degrees of importance that are stored by degree of importance storage unit 22, and the usability evaluation points that are stored by evaluation point storage unit 23.

The example shown in FIG. 5 is for a case in which usability evaluation is carried out for three models of personal computers (the names of these personal computers being PC_A, PC_B, and PC_C).

As shown in FIG. 5, evaluation items 201 represent the evaluation items of the first hierarchy, and evaluation items 202 represent the evaluation items of the second hierarchy into which the evaluation items of the first hierarchy have been subdivided. In the example shown in FIG. 5, the second hierarchy is the lowest level.

Although evaluation items 202 of the second hierarchy are shown only for “menu” of evaluation items 201 in order to avoid complexity of the figure, there are also evaluation items of the second hierarchy for the other evaluation items 201 of the first hierarchy (such as display, keyboard, and guidance) as for “menu.” However, no problems are raised in the operations of the usability evaluation apparatus of the present exemplary embodiment even when there are no evaluation items 202 of the second hierarchy or when there are evaluation items of a third and successive hierarchies into which the second hierarchy has been further subdivided.

In addition, as shown in FIG. 5, degrees of importance 203 are conferred to first-hierarchy evaluation items 201, and degrees of importance 204 are conferred to second-hierarchy evaluation items 202. These degrees of importance are shown as numerical values enclosed in parentheses ( ) in FIG. 5. These degrees of importance represent the relative degrees of importance among evaluation items of the same hierarchy. FIG. 5 shows a normalized case in which the sum of the degrees of importance of evaluation items of the same hierarchy is made to equal 1.0, but because the normalization process is simple, there is no need to impose a condition requiring the sum of the degrees of importance to equal 1.0.

As shown in FIG. 5, evaluation object names 205 are placed in correspondence with each of evaluation items 202 of the lowest level (second hierarchy). In addition, usability evaluation points 206 of usability evaluation are determined for each of evaluation object names 205, and these are shown as numerical values enclosed in parentheses ( ) in FIG. 5.

In the example shown in FIG. 5, usability evaluation points 206 are assumed to be determined within a range of 0-10 points, but the range of the scores is not limited to this range.

Referring again to FIG. 4, data processing apparatus 10 is equipped with tree map data calculation unit 11, tree map depiction unit 12, graph data calculation unit 13, and graph depiction unit 14.

Tree map data calculation unit 11 calculates tree map data for depicting a tree map, which is a figure in which evaluation items 201 and 202 are represented as rectangular regions, for each of evaluation items 201 and 202 based on evaluation items 201 and 202 and the hierarchical structure of evaluation items 201 and 202 that are stored in evaluation item storage unit 21 of storage device 20 and the degrees of importance 203 and 204 of evaluation items 201 and 202 that are stored in degree of importance storage unit 22.

Tree map depiction unit 12 depicts tree maps based on the tree map data that were calculated by tree map calculation unit 11 and causes output device 30 to supply the tree map that was depicted.

Graph data calculation unit 13 acquires the tree map data of each of evaluation items 201 and 202 from tree map data calculation unit 11 and further acquires usability evaluation points 206 of evaluation object names 205 from evaluation point storage unit 23. Graph data calculation unit 13 then calculates depiction data for depicting graphs of the usability evaluation points within the rectangular regions of lowest-level evaluation items 202 on the tree map based on the tree map data and usability evaluation points that were acquired.

Graph depiction unit 14 depicts graphs showing the usability evaluation points within the rectangular regions of the lowest-level evaluation items 202 on the tree map that was supplied by output device 30 based on the depiction data that was calculated by graph data calculation unit 13.

The operations of supplying usability evaluation results by usability evaluation apparatus 100 that is configured as described above are next described.

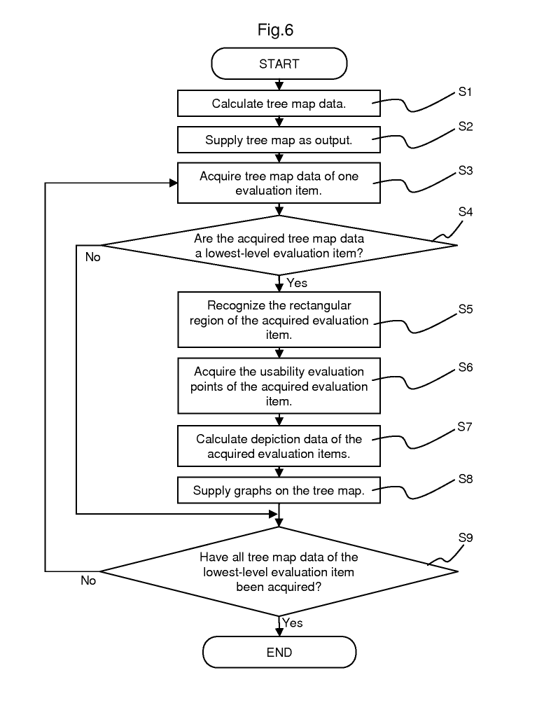

FIG. 6 is a flow chart for describing an example of the operations of supplying usability evaluation results by usability evaluation apparatus 100 shown in FIG. 4.

Tree map data calculation unit 11 first acquires evaluation items 201 and 202 and the hierarchical structure of evaluation items 201 and 202 that are stored in evaluation item storage unit 21 of storage device 20 and degrees of importance 202 and 204 of evaluation items 201 and 202 that are stored in degree of importance storage unit 22 and then calculates for each of evaluation items 201 and 202 tree map data for depicting tree maps based on these data (Step S1).

Tree map depiction unit 12 then depicts tree maps based on the tree map data that were calculated by tree map data calculation unit 11 and causes output device 30 to supply the depicted tree maps to (Step S2).

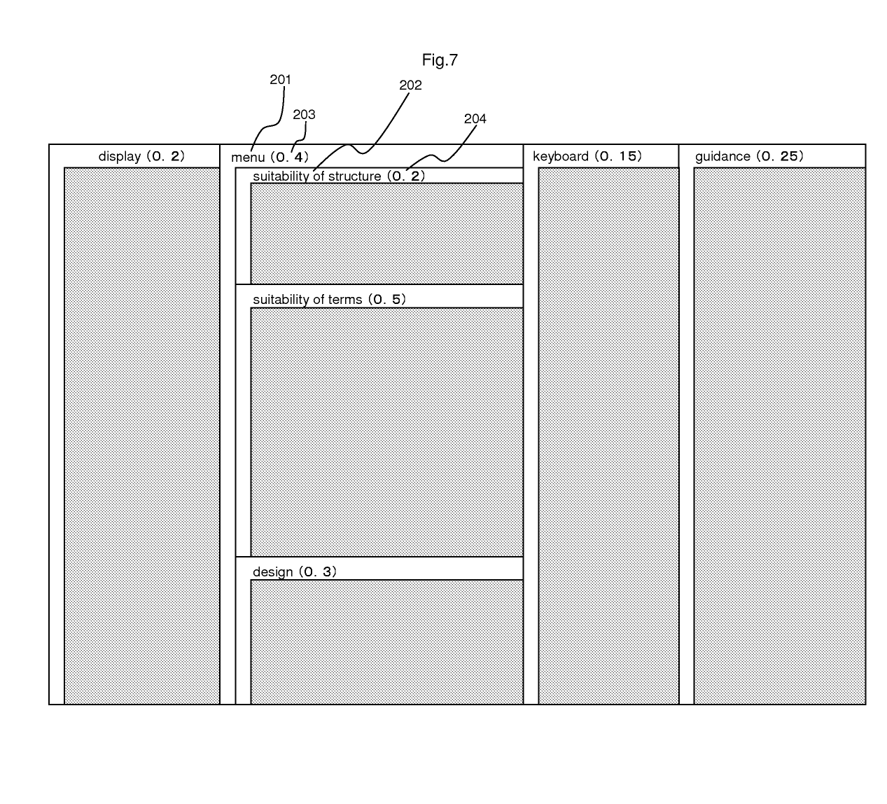

FIG. 7 shows an example of a tree map that is supplied by output device 30 shown in FIG. 4.

The tree map shown in FIG. 7 is represented by rectangular regions whose positions of arrangement and shapes that accord with the hierarchical structure of evaluation items 201 and 202 and degrees of importance 203 and 204. For example, rectangular areas that indicate “suitability of structure,” “suitability of terms” and “design,” which are lower-hierarchy evaluation items 202 of “menu,” are arranged in the rectangular region that indicates evaluation item 201 “menu.” In addition, the rectangular region that indicates “suitability of terms” having the highest degree of importance among evaluation items 202 of the lower-order hierarchy of evaluation item 201 “menu” is larger than the other rectangular regions that indicate “suitability of structure” and “design.”

Graph data calculation unit 13 next acquires the tree map data of one evaluation item from tree map data calculation unit 11 (Step S3).

Graph data calculation unit 13 next determines whether the acquired tree map data are of the lower-level evaluation items 202 (Step S4).

When, as a result of the determination in Step S4, the acquired tree map data are determined to be of lowest-level evaluation items 202, graph data calculation unit 13 recognizes the positions of arrangement and shape of the rectangular regions of evaluation items 202 from the tree map data that were acquired from tree map data calculation unit 11 in Step S3 (Step S5).

Graph data calculation unit 13 acquires from evaluation point storage unit 23 the usability evaluation points of each evaluation object that corresponds to evaluation items 202 of the tree map data that were acquired from tree map data calculation unit 11 in Step S3 (Step S6).

Graph data calculation unit 13 next calculates depiction data for depicting graphs indicating the usability evaluation points of each evaluation object that was acquired in Step S6 inside the rectangular regions that were recognized in Step S5 (Step S7).

Based on the depiction data that are calculated by graph data calculation unit 13, graph depiction unit 14 depicts graphs showing usability evaluation points inside the rectangular regions of lowest-level evaluation items 202 on the tree map supplied in Step S2 and causes output device 30 to supply the graphs that were depicted (Step S8).

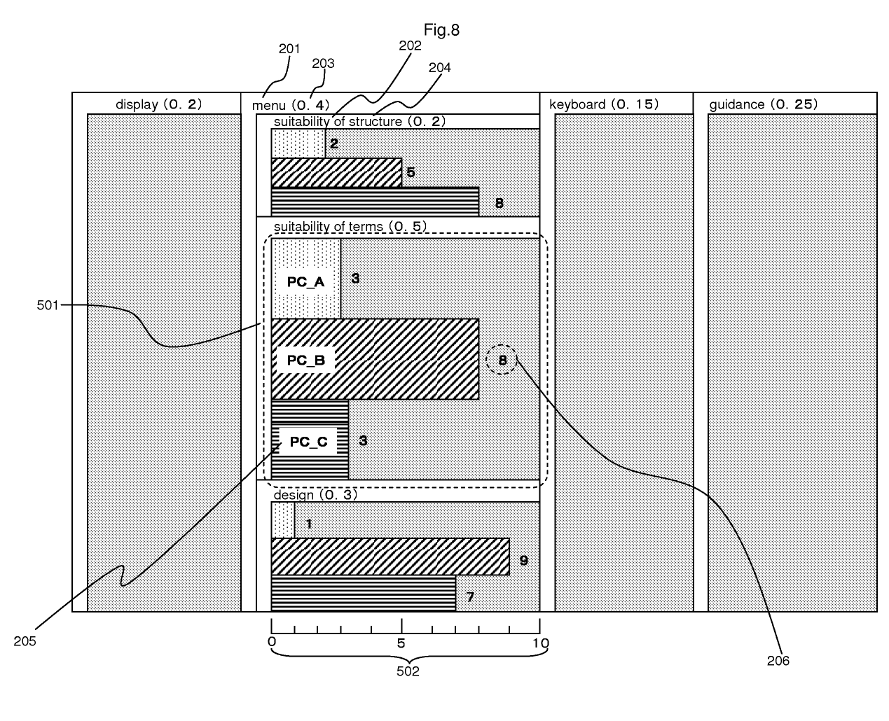

FIG. 8 shows an example of the state in which graphs of the usability evaluation points are depicted on the tree map shown in FIG. 7.

In the example shown in FIG. 8, the length in the horizontal direction of rectangular region 501 showing evaluation item 202 “suitability of terms” is a usability evaluation score of 10 points. In this case, 3 points, 8 points, and 3 points, which are the usability evaluation points of PC_A, PC_B, and PC_C, are represented as a bar graph of the lengths shown in FIG. 8. The user who refers to the usability evaluation result is thus able to visually compare and evaluate the absolute values of the usability evaluation points of PC-A-PC-C that are the objects of evaluation.

In the example shown in FIG. 8, the usability evaluation points for other evaluation items 202 “suitability of structure” and “design” of each evaluation object are similarly represented by bar graphs. The user is thus able to view in a single screen the evaluation items, the degrees of importance of these evaluation items, and the usability evaluation points for each evaluation item, and moreover, is able to visually compare and evaluate the absolute values of the usability evaluation points of each evaluation object.

Although evaluation object names 205, usability evaluation points 206, and graduations 502 showing the scale of the bar graphs are supplied in FIG. 8, these are features that assist reading of the graphs by the user and the output of these features on the tree map can be easily realized without any special contrivance.

Graph data calculation unit 13 next determines whether all tree map data of lowest-level evaluation items 202 have been acquired from tree map data calculation unit 11 (Step S9).

If, as a result of the determination in Step S9, all tree map data of lowest-level evaluation items 202 have been acquired from tree map data calculation unit 11, the process is terminated.

On the other hand, if, as a result of the determination in Step S9, all tree map data of lowest-level evaluation items 202 have not been acquired from tree map data calculation unit 11, the process returns to the operation of Step S3, and the operations of Steps S3-S9 are repeated until all tree map data of lowest-level evaluation item 202 have been acquired from tree map data calculation unit 11 and graphs of the usability evaluation result are depicted on the tree map.

If, as a result of the determination in Step S4, the tree map data acquired from tree map data calculation unit 11 are not for lowest-level evaluation items 202, the process moves to the operation of Step S9, and graph data calculation unit 13 determines whether all tree map data of lowest-level evaluation items 202 have been acquired from tree map data calculation unit 11.

Although a case of depicting bar graphs in a horizontal direction on a tree map has been described in the present exemplary embodiment, the determination of the direction of depiction of bar graphs can be realized according to the shapes of the rectangular regions of lowest-level evaluation items 202. For example, when the shape of rectangular region 501 shown in FIG. 8 is longer in the vertical direction, vertical bar graphs should be depicted in consideration of the ease of viewing. This modification can be realized in graph data calculation unit 13 that calculates depiction data after having recognized the shape and position of arrangement of the rectangular regions.

In the present exemplary embodiment, a case is described in which bar graphs are drawn on a tree map. However, the figures that are drawn on the tree map are not limited to bar graphs, and line graphs or area graphs may also be depicted.

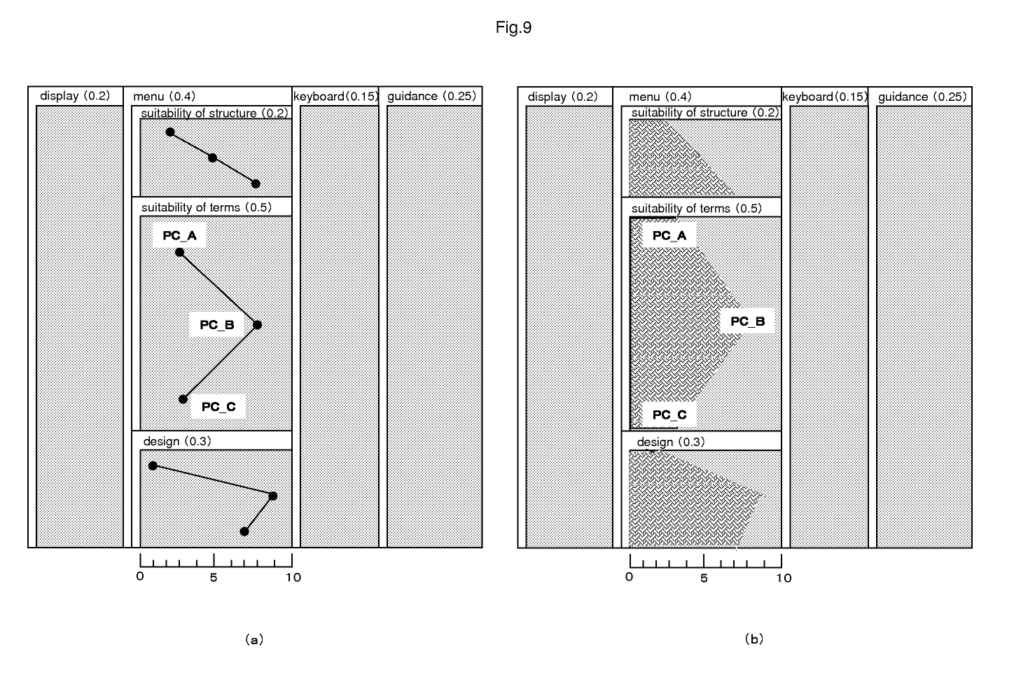

FIG. 9 is a view showing other examples of states in which graphs of usability evaluation points are depicted on the tree map shown in FIG. 7, (a) showing the state in which line graphs are depicted, and (b) showing a state in which area graphs are depicted.

As shown in FIG. 9, the effect of enabling the visual comparison and evaluation of the absolute values of usability evaluation points by bar graphs is similarly obtained by graphs other than bar graphs.

Thus, in the first exemplary embodiment, the usability evaluation points of evaluation objects are depicted as graphs inside rectangular regions of the corresponding evaluation items on a tree map that is depicted according to the hierarchical structure of evaluation items and the degrees of importance of the evaluation items.

As a result, evaluation items, the degrees of importance of these evaluation items, and the usability evaluation points for each evaluation item can be viewed within a single screen, and further, the usability evaluation points of each evaluation object can be compared and evaluated by absolute values rather than by ratios.

### Second Exemplary Embodiment

In the above-described first exemplary embodiment, operations were described for supplying as output graphs that indicate the usability evaluation results for the lowest-level evaluation items 202. In the second exemplary embodiment, operations are described for a case in which graphs showing the usability evaluation results for lowest-level evaluation items 202 that have already been supplied on a tree map are converted to graphs showing the usability evaluation results for higher-order hierarchy evaluation items 201.

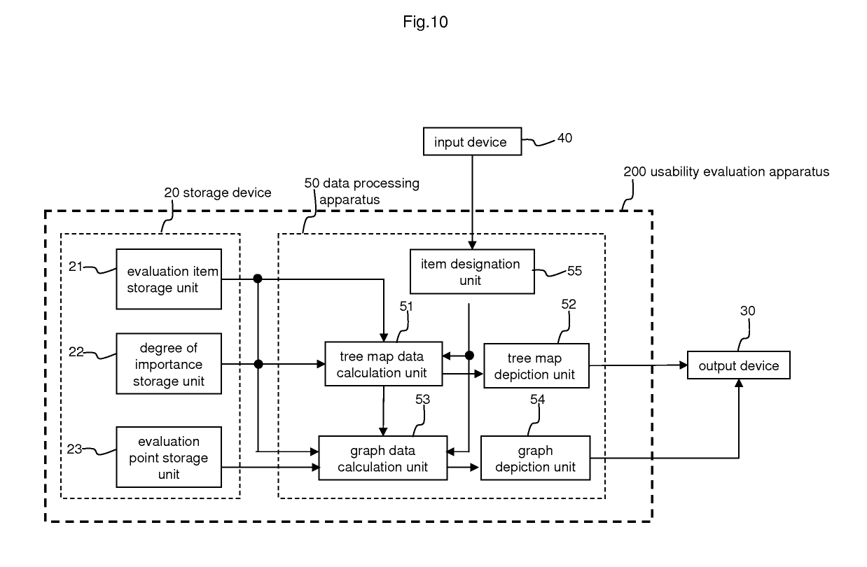

FIG. 10 is a block diagram showing the configuration of the second exemplary embodiment of the usability evaluation apparatus of the present invention.

As shown in FIG. 10, usability evaluation apparatus 200 of the present exemplary embodiment differs from usability evaluation apparatus 100 shown in FIG. 4 in that it is equipped with item designation unit 55.

In addition, input device 40 that is constituted by a pointing device such as a keyboard or mouse by which a user designates any evaluation items on a tree map that is supplied to output device 30 is connected to data processing apparatus 50.

Item designation unit 55 is provided in data processing apparatus 50 and converts evaluation items that are designated by the operation of input device 40 by a user to an ID (Identification) that uniquely identifies that evaluation item and supplies the converted ID to tree map data calculation unit 51 and graph data calculation unit 53. This ID is used in common in the processing in data processing apparatus 50.

Operations in usability evaluation apparatus 200 that is constituted as described hereinabove are next described regarding a case in which graphs showing the usability evaluation results for lowest-level evaluation items 202 that are already supplied on a tree map are switched to graphs showing the usability evaluation results for higher-order evaluation items 201.

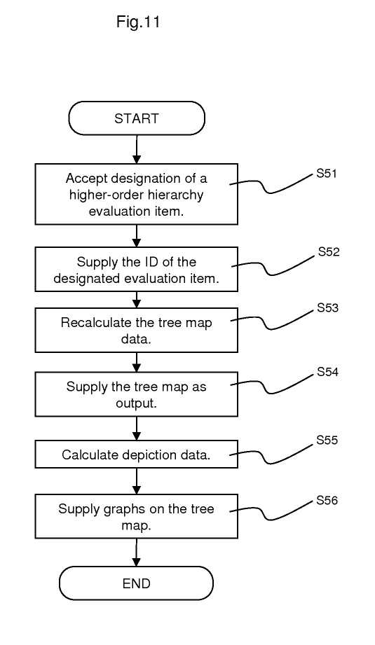

FIG. 11 is a flow chart for describing an example of the operations for supplying the usability evaluation results by usability evaluation apparatus 200 shown in FIG. 10.

The user of usability evaluation apparatus 200 first operates input device 40 to select higher-order hierarchy evaluation items 201 that he or she wishes to supply as output.

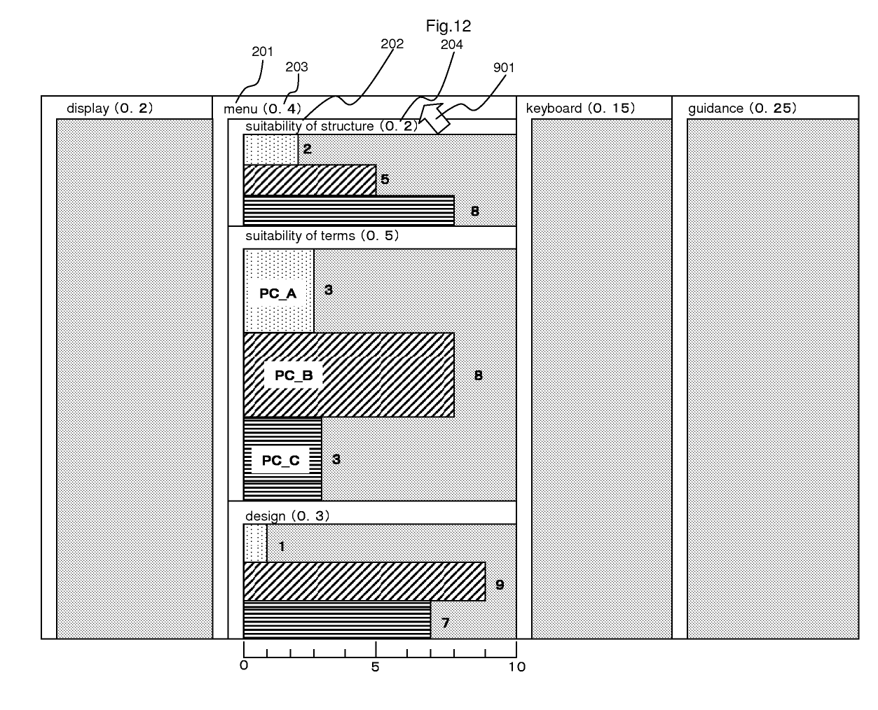

FIG. 12 shows another example of the state in which graphs of usability evaluation points are depicted on the tree map shown in FIG. 7.

In the current stage as shown in FIG. 12, graphs showing the usability evaluation results for lowest-level evaluation items 202 are supplied in higher-order hierarchy evaluation item 201 “menu.” Higher-order hierarchy evaluation item 201 “menu” is selected by cursor 901 that moves over the tree map under the operation of input device 40 by the user.

Item designation unit 55 receives input for designating a higher-order hierarchy evaluation item 201 based on the tree map data of the current stage in which tree map data calculation unit 51 has completed calculation and information (normally, coordinate data on a screen) designated by means of the operation of input device 40 by the user (Step S51).

Item designation unit 55 then converts higher-order hierarchy evaluation item 201 that was designated to an ID that uniquely identifies evaluation item 201 that was designated and supplies the converted ID to tree map data calculation unit 51 and graph data calculation unit 53 (Step S52).

Tree map data calculation unit 51 acquires the ID of higher-order hierarchy evaluation item 201 that was designated from item designation unit 55. Tree map data calculation unit 51 then acquires evaluation items 201 and 202 and the hierarchical structure of evaluation items 201 and 202 that are stored in evaluation item storage unit 21 of storage device 20 and degrees of importance 203 and 204 of evaluation items 201 and 202 that are stored in degree of importance storage unit 22, and based on these, calculates tree map data for supplying a tree map in which higher-order hierarchy evaluation item 201 indicated by the ID that was acquired from item designation unit 55 is the lowest-level (Step S53). In the simplest process, the calculation of the tree map data in this case can be realized by deleting all of lower-hierarchy evaluation items 202 of evaluation item 201 “menu.”

Tree map depiction unit 52 depicts a tree map based on the tree map data that was calculated by tree map data calculation unit 51 and causes output device 30 to supply the depicted tree map as output (Step S54).

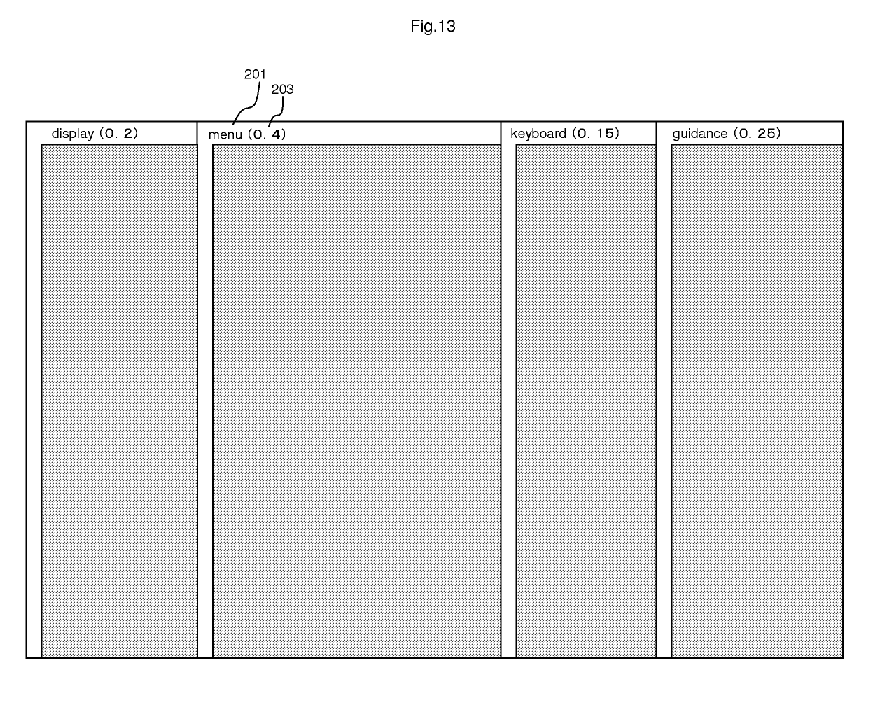

FIG. 13 shows an example of a tree map supplied by output device 30 shown in FIG. 10.

Comparing with the tree map shown in FIG. 7, the tree map shown in FIG. 13 differs in that lower-hierarchy evaluation items 202 are not supplied.

Graph data calculation unit 53 next acquires the ID of higher-order hierarchy evaluation item 201 that was designated from item designation unit 55. Graph data calculation unit 53 then acquires evaluation items 201 and 202 that are stored in evaluation item storage unit 21 of storage device 20, the degrees of importance of evaluation items 201 and 202 that are stored in degree of importance storage unit 22, and the usability evaluation points that are stored in evaluation point storage unit 23, and based on these, calculates the usability evaluation points for higher-order hierarchy evaluation item 201 that is indicated by the ID that was acquired from item designation unit 55. Graph data calculation unit 53 then calculates depiction data for drawing graphs showing the usability evaluation points that were calculated within the rectangular regions of that evaluation item 201 (Step S55).

As an example, the usability evaluation points of PC_A-PC_C for evaluation item 201 “menu” are calculated by multiplying the degrees of importance of lowest-level evaluation items 202 (such as “suitability of structure”) by the usability evaluation points of the evaluation objects and then adding the multiplied usability evaluation points. In other words, the usability evaluation points for evaluation item 201 “menu” of each of the evaluation objects are calculated by the calculation equations shown below.

Usability evaluation points for “menu”=

degree of importance of “suitability of structure”×usability evaluation points of “suitability of structure”

+degree of importance of “suitability of terms”×usability evaluation points of “suitability of terms”

+degree of importance of “design”×usability evaluation points of “design.”

In other words, if the usability evaluation points of evaluation item 201 “menu” of PC_A-PC_C shown in FIG. 12 are U_A-U_C, respectively, then:

U_{—}A=0.2×2+0.5×3+0.3×1=2.2

U_{—}B=0.2×5+0.5×8+0.3×9=7.7

U_{—}C=0.2×8+0.5×3+0.3×7=5.2

Higher-order hierarchy evaluation items still exist, and when these are designated, the usability evaluation points for any evaluation item can be found and their graphs depicted by recursively repeating the above-described operations.

Based on the depiction data that were calculated by graph data calculation unit 53, graph depiction unit 54 depicts graphs showing the usability evaluation points inside the rectangular regions of higher-order hierarchy evaluation items 201 that were designated on the tree map that was supplied in Step S54 and causes output device 30 to supply the depicted graphs (Step S56).

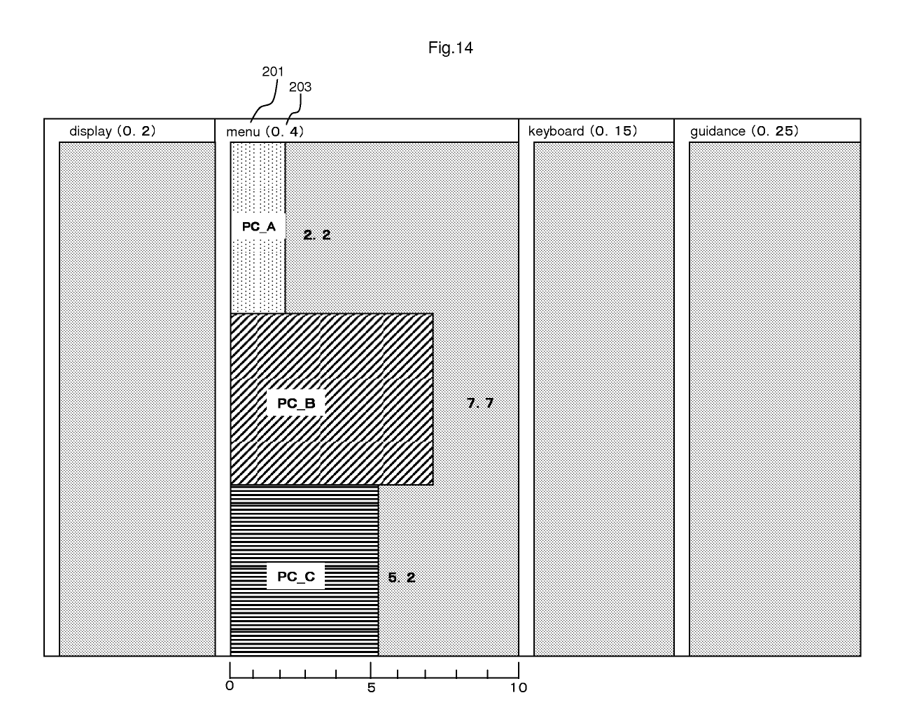

FIG. 14 shows an example of the state in which graphs of usability evaluation points are depicted on the tree map shown in FIG. 13.

In the example shown in FIG. 14, graphs showing usability evaluation points for higher-order hierarchy evaluation item 201 “menu” are depicted for each evaluation object and graphs for each lower-order hierarchy evaluation item 202 are not depicted.

Thus, in the second exemplary embodiment, a tree map is depicted such that the evaluation items designated by the user are the lowest level. Still further, usability evaluation points of each evaluation object are calculated for the designated evaluation items, and the calculated usability evaluation points are depicted as graphs on the tree map. Accordingly, the user is able to directly compare the usability evaluation points for any desired evaluation item.

The processes in a usability evaluation apparatus in the present invention, in addition to being realized by the above-described dedicated hardware, may also be realized by recording a program for realizing the functions of these processes on a recording medium that can be read by a usability evaluation apparatus and then reading the program that has been recorded on this recording medium to the usability evaluation apparatus and executing the program. The recording medium that can be read in the usability evaluation apparatus refers to a relocatable recording medium such as a floppy disk, a magneto-optical disk, a DVD, or a CD, or to an HDD that is incorporated in a usability evaluation apparatus.

This application claims priority based on Japanese Patent Application No. 2008-201848 for which application was submitted on Aug. 5, 2008 and incorporates all of the disclosures of that application.

1. A usability evaluation apparatus that evaluates usability of evaluation objects by means of evaluation items that have a hierarchical structure that is divided into a plurality of hierarchies and that supplies as output to an output device usability evaluation points that are the evaluation results; wherein:
said usability evaluation apparatus causes said output device to supply as output a tree map that has a shape that accords with degrees of importance that indicate the relative importance of said evaluation items within said hierarchy and that represents regions of said evaluation items such that said hierarchical structure can be distinguished and graphs that indicate the absolute values of said usability evaluation points such that said graphs are depicted in regions that indicate the lowest-level evaluation items on said tree map in accordance with the shapes of said regions.

2. The usability evaluation apparatus as set forth in claim 1, comprising:
an evaluation item storage unit that stores said evaluation items and said hierarchical structure;
a degree of importance storage unit that stores said degrees of importance in association with said evaluation items;
an evaluation point storage unit that stores usability evaluation points for said lowest-level evaluation items in association with said evaluation items;
tree map data calculation unit that, based on said evaluation items and said hierarchical structure that were acquired from said evaluation item storage unit and said degrees of importance that were acquired from said degree of importance storage unit, calculates tree map data for depicting said tree map;
tree map depiction unit that depicts a tree map based on said tree map data and causes output by said output device;
graph data calculation unit that, based on said usability evaluation points that were acquired from said evaluation point storage unit and said tree map data, calculates depiction data for causing said output device to supply graphs showing absolute values of said usability evaluation points such that said graphs are depicted in regions that indicate the lowest-level evaluation items on said tree map according to the shape of said regions; and
graph depiction unit that causes said output device to supply graphs based on said depiction data.

3. The usability evaluation apparatus as set forth in claim 2, wherein said graph data calculation unit determines the type of graphs that are depicted according to the shape of regions that show the lowest-level evaluation items on said tree map.

4. The usability evaluation apparatus as set forth in claim 1, wherein:
said tree map in which designated evaluation items are the lowest level and graphs showing the absolute values of usability evaluation points of said evaluation items that are designated are supplied by said output device such that said graphs are depicted in regions that indicate the lowest-level evaluation items on said tree map according to the shape of said regions.

5. The usability evaluation apparatus as set forth in claim 4 comprising:
an evaluation item storage unit that stores said evaluation items and said hierarchical structure;
a degree of importance storage unit that stores said degrees of importance in association with said evaluation items;
an evaluation point storage unit that stores usability evaluation points for said lowest-level evaluation items in association with said evaluation items;
item designation unit that accepts designation of any evaluation item and supplies an ID that indicates said evaluation item that was designated;
tree map data calculation unit that, upon receiving output of ID from said item designation unit, calculates tree map data for depicting said tree map in which the evaluation item indicated by said ID is the lowest level based on said evaluation items and said hierarchical structure that were acquired from said evaluation item storage unit and said degrees of importance that were acquired from said degree of importance storage unit;
tree map depiction unit that depicts a tree map based on said tree map data and causes output by said output device;
graph data calculation unit that, upon receiving output of ID from said item designation unit, calculates usability evaluation points of the evaluation item that is indicated by said ID based on said evaluation items that were acquired from said evaluation item storage unit, said degrees of importance that were acquired from said degree of importance storage unit, and said usability evaluation points that were acquired from said evaluation point storage unit, and based on said usability evaluation points that were calculated and said tree map data, calculates depiction data for causing said output device to supply graphs showing absolute values of said usability evaluation points that were calculated such that said graphs are depicted in regions that indicate the lowest-level evaluation items on said tree map according to the shape of said regions; and
graph depiction unit that causes said output device to supply graphs based on said depiction data.

6. A usability evaluation method in a usability evaluation apparatus that evaluates usability of evaluation objects by means of evaluation items that have a hierarchical structure that is divided into a plurality of hierarchies and that supplies usability evaluation points that are evaluation results to an output device; wherein said usability evaluation method comprises:
a process of causing said output device to supply as output a tree map that has a shape that accords with degrees of importance that indicate relative importance of said evaluation items within said hierarchy and that represents regions that indicate said evaluation items such that said hierarchical structure can be distinguished and graphs that indicate absolute values of said usability evaluation points such that said graphs are depicted within regions that indicate the lowest-level evaluation items on the tree map in accordance with the shapes of said regions.

7. The usability evaluation method as set forth in claim 6, comprising processes of:
calculating tree map data for depicting said tree map based on said evaluation items, said hierarchical structure, and said degrees of importance;
calculating depiction data based on said usability evaluation points and said tree map data for causing said output device to supply as output graphs showing absolute values of said usability evaluation points such that said graphs are depicted within regions that indicate the lowest-level evaluation items on said tree map according to the shape of said regions; and
causing said output device to supply a tree map based on said tree map data and graphs based on said depiction data.

8. The usability evaluation method as set forth in claim 7, further comprising a process of determining the type of depicted graphs according to the shape of the regions that indicate the lowest-level evaluation items on said tree map.

9. The usability evaluation method as set forth in claim 6, further comprising a process of causing said output device to supply as output said tree map in which a designated evaluation item is the lowest level and graphs that indicate absolute values of usability evaluation points of said evaluation item that was designated such that said graphs are depicted in regions showing the lowest-level evaluation items on said tree map according to the shapes of said regions.

10. The usability evaluation method as set forth in claim 9, comprising processes of:
accepting designation of any evaluation item and supplying an ID showing said evaluation item that was designated;
upon receiving output of said ID, calculating tree map data for depicting said tree map in which the evaluation item that is indicated by said ID is the lowest level based on said evaluation item, said hierarchical structure, and said degrees of importance; calculating usability evaluation points of the evaluation item that is indicated by said ID based on said evaluation items, said degrees of importance, and said usability evaluation points; and, based on usability evaluation points that were calculated and said tree map data, calculating depiction data for causing said output device to supply graphs indicating absolute values of said usability evaluation points that were calculated such that said graphs are depicted within regions that indicate the lowest-level evaluation items on said tree map according to the shape of said regions; and
causing said output device to supply a tree map based on said tree map data and graphs based on said depiction data.

11-15. (canceled)

16. A computer readable recording medium in which a program is recorded, said program that causes a usability evaluation apparatus, which evaluates usability of evaluation objects by means of evaluation items that have a hierarchical structure that is divided into a plurality of hierarchies and that supplies usability evaluation points that are evaluation results to an output device, to realize a function of:
causing said output device to supply as output a tree map that has a shape that accords with degrees of importance that indicate the relative importance of said evaluation items within said hierarchy and that represents regions that indicate said evaluation items such that said hierarchical structure can be distinguished and graphs that indicate absolute values of said usability evaluation points such that said graphs are depicted within regions that indicate the lowest-level evaluation items on said tree map according to the shapes of said regions.

17. The computer readable recording medium as set forth in claim 16, said program causing realization of functions of:
calculating tree map data for depicting said tree map based on said evaluation items, said hierarchical structure, and said degrees of importance;
calculating depiction data for causing said output device to supply as output graphs indicating absolute values of said usability evaluation points based on said usability evaluation points and said tree map data such that said graphs are depicted in regions indicating the lowest-level evaluation items on said tree map according to the shape of said regions; and
causing said output device to supply as output a tree map based on said tree map data and graphs based on said depiction data.

18. The computer readable recording medium as set forth in claim 17, said program causing realization of a function of determining types of graphs that are depicted according to the shape of regions that indicate the lowest-level evaluation items on said tree map.

19. The computer readable recording medium as set forth in claim 16, said program causing realization of a function of causing said output device to supply as output said tree map in which an evaluation item that is designated is the lowest level and graphs that indicate absolute values of usability evaluation points of said evaluation item that is designated such that said graphs are depicted in regions indicating the lowest-level evaluation items on said tree map according to the shape of said regions.

20. The computer readable recording medium as set forth in claim 19, said program causing realization of functions of:
accepting designation of any evaluation item and supplying an ID that indicates said evaluation item that was designated;
upon receiving output of said ID, calculating tree map data based on said evaluation items, said hierarchical structure, and said degrees of importance to depict said tree map in which the evaluation item indicated by said ID is the lowest level;
calculating usability evaluation points of the evaluation item indicated by said ID based on said evaluation items, said degrees of importance, and said usability evaluation points; and based on said usability evaluation points that were calculated and said tree map data, calculating depiction data for causing said output device to supply as output graphs that indicate absolute values of said usability evaluation points that were calculated such that said graphs are depicted in regions that indicate the lowest-level evaluation items on said tree map according to the shapes of said regions; and causing said output device to supply as output a tree map based on said tree map data and graphs based on said depiction data.
